(19) United States
(12) Patent Application Publication
(10) Pub. No.: US 2005/0276399 A1
(43) Pub. Date: Dec. 15, 2005

(54) Method for determining sequence of play of a collection of telephone audio advertisements

(76) Inventor: Tony Otha Thompson, McLean, VA (US)

Correspondence Address: Tony Otha Thompson, Apt. 121, 1504 Lincoln Way, McLean, VA, 22102, US

(21) Appl. No.: 11/150,918

(22) Filed: Jun. 13, 2005

Related U.S. Application Data
(60) Provisional application No. 60/578,843, filed on Jun. 14, 2004.

(51) Int. Cl. H04M 11/00; H04M 1/00

(52) U.S. Cl. 379/93.12; 379/101.01

(57) ABSTRACT

A method for voice based directory assistance providers and advertisers to manage and communicate directory listing information to voice based directory assistance users. The method includes means for generating and playing a compilation of audio advertisements and means for generating and executing a playlist of audio advertisements.

### CLAIM OF PRIORITY

This patent application claims the benefit of the filing date of U.S. Provisional Application Ser. No. 60/578,843 filed on Jun. 14, 2004.

### FIELD OF THE INVENTION

This invention relates to a system for determining sequence of play of a collection of telephone audio advertisements.

### DESCRIPTION OF RELATED ART

Consumers (searchers) can locate advertisers using operator assisted telephone directory assistance (“traditional phone search”). Traditional phone search is very primitive. A searchers uses traditional phone search by calling a live operator at a designated telephone number. The searchers must then specify the name of the advertiser for whom he is looking and optionally that merchant's city. The operator will then manually locate that particular advertiser from within a paper database (directory) of merchants. Finally, the operator reads the telephone number for that advertiser to the searchers over the telephone.

Although traditional phone search is very primitive, several modest improvements to it have been made. One such improvement provides means for the live operator to electronically locate a particular advertiser from within an electronic database. Another such improvement enables the live operator, after locating the advertiser from within a database, to transfer the call to a computer that then “speaks” the telephone number to the searchers. Yet another such improvement enables a computer to “speak” an advertisement to a searchers as well as a phone number. Still another such improvement enables the searchers, after hearing listing information for a particular advertiser from a computer, to instruct a computer to automatically call that advertiser by pressing a key on his telephone keypad. An example of such an improvement is described in U.S. Pat. No. 4,757,267.

Even taking together all these improvements, traditional phone search still suffers from two fundamental deficiencies. First, traditional phone search forces a searchers to search for a single advertiser rather than enabling him to search for several advertisers who may fall within some specified category. To illustrate, oftentimes a searchers wants to hear a list of advertisements for many advertiser in the “pizza” category rather than hear an advertisement only for “Charlie's Pizza.” Yet traditional phone search requires a searcher to specify the name of a single advertiser and then forces him to hear the advertisement of that single advertiser only.

Second, traditional phone search does not provide a selection of advertisers from which a searcher can chose. Therefore, traditional search cannot enable an advertiser to enhance its advertisement by, for example, paying to place its advertisements in a preferential spot in the selection list. To illustrate, suppose a phone search by a consumer generates a collection of audio advertisements for listening by telephone. An advertiser would appreciate the ability to locate his advertisement first in the play sequence.

### SUMMARY OF THE INVENTION

The object of the this invention is to simultaneously solve these two deficiencies by providing means for implementing a functioning market whereby multiple advertisers vie for position in sequence of play of a collection of phone audio advertisements which is generated in response to a phone search by a consumer.

This invention generally revolves around databases, interactions of advertisers with those databases, and interactions of phone searchers with those databases.

The databases may contain listings, playlists and compilations. Each listing may contain any of an advertiser, an advertisement, a bid term, a bid, optionally an advertiser target, a forwarding telephone number and optionally delivery instructions. An advertisement may be an audio file such as a mpg file, a string of text for conversion to speech using text to speech technology (TTS), or any other type media appropriate for rendering on a telephone or other client device (“telephone”). An advertisement may or may not include a selection prompt such as “press 1 for.” A bid term may be a word or words. A bid term may also be a node in a directory structure. A bid is made on a bid term and may be in any measure of value such as currency or points. An advertiser target may be a geographic area such as a zip code, a demographic group such as teenagers or any other limiting factor. A forwarding telephone number may be any telephone number selected by the advertiser. Delivery instructions specify whether a searcher will hear audio of a selected advertiser's telephone number or whether his telephone call will be forwarded to a selected advertiser's telephone number. It will be appreciated that some of the figures herein may omit some components of a listing for clarity.

A playlist is a particular order of play of advertisements or instructions for order of play of advertisements. It is important to note that a searcher will never see a play list; he will only hear the advertisements in the playlist on the telephone. Moreover, a searcher may not even hear all advertisements in the play list; he may select a particular advertisement or listing well before all advertisements are played. An advertisement in a play list can be an actual advertisement or a location of an actual advertisement.

A compilation is a single piece of media made from a collection of advertisements. A compilation may be a single audio file, a string of text for conversion to speech or any other type of media appropriate for rendering on a telephone. A compilation may be made by concatenating together a collection of advertisements, newly creating a piece of media based on the contents of a collection of advertisements, or by any other means appropriate for creating a single piece of media from a collection of advertisements.

Sequence of play of the advertisements in a playlist and compilation is important. Sorting may be used to sequencing the advertisements in a playlist. An identifier indicating the ranking of each advertisement in play order may also be used to sequence the advertisements in a play list.

Playlists and compilations are generated in advance of a search whenever an advertiser revises an existing listing or adds a new listing. An advertiser may create or modify a listing by using a telephone or a computer.

To execute a search, a searcher first calls a general search telephone number or a local telephone number. Both general and local search numbers can deliver local and non-local advertisements. A search term and optionally a target term are submitted. A search term may be a word or words. A search term may also be a node in a directory after navigation to that node using either touch-tine pad (DTMF) navigation or spoken navigation using speech recognition technology. The search term is submitted and received using voice recognition technology, DTMF recognition technology or standard text recognition technology such as HTML submission technology. The searcher or any third party or data source may submit the target term.

Upon receipt of a search term and an optional target term, a playlist is executed, a play list is generated and executed, a compilation is played or a compilation is generated a played. At any point during execution of the playlist or play of the compilation, the searcher may barge-in and select an advertisement. In no particular order, that selection is recorded and the searcher either hears the selected advertiser's phone number or is forwarded to that phone number.

### DETAILED DESCRIPTION OF THE INVENTION

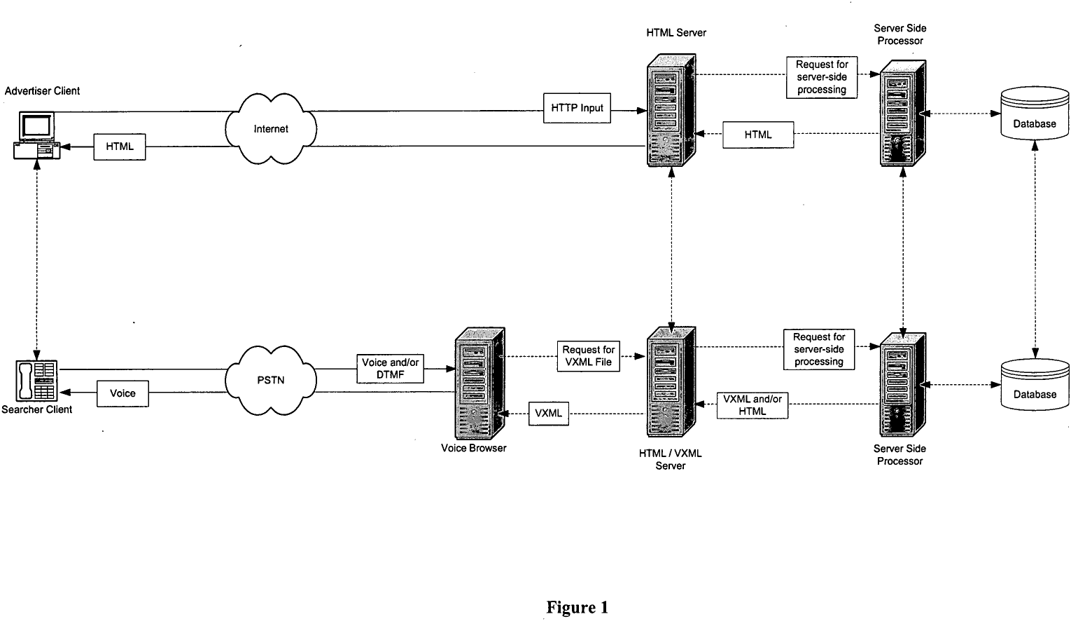

The block diagram of FIG. 1 shows a plurality of voice clients (such as a telephone) that may access a server across a network (such as the internet or the PSTN). With spoken voice and/or DTMF input, a searcher uses a telephone to submit a search term and optionally a target term to a voice browser. When receiving telephone input such as a DTMF search term, a voice browser converts that input into high-level software statements such as VXML. That VXML, which contains at least the search term and optional target term, is then submitted to a VXML server. The VXML server and a client server-side processor will execute instructions to generate or retrieve a playlist or a compilation from a database. The VXML server then delivers the playlist or compilation to the voice browser in the form of VXML instructions. The voice browser executes the playlist or plays the compilation by rendering the VXML instructions into voice audio heard by the searcher on his telephone. At any point during execution of the playlist or play of the compilation, the searcher may barge-in and select an advertisement by speaking his selection or indicating his selection with DTMF input.

The block diagram of FIG. 1 also shows a plurality of advertiser clients that may access a server across a network (such as the internet or PSTN). An advertiser revises a listing or add a listing by using a client program such as a browser to submit HTTP input to an HTML server. The HTML server and an advertiser server side processor will execute instructions to generate, maintain and store playlists and compilations.

It will be appreciated that the method of the present invention may be implemented in software that is stored as executable instructions typically on a client server-side processor or an advertiser server-side processor, or both. It will also be appreciated that this architecture is only one of many that may be used to implement this invention. For example, as indicated by the dotted lines on

FIG. 1, each of the HTML server, the HTML/VXML server, the client server-side processor, the advertiser server-side processor, the client database, or the advertiser database may be on the same computer or multiple computers. It will also be appreciated that search clients may be a computer and an advertiser may be a telephone. The voice browser, the HTML/VXML server, the client server-side processor and the client database are sometimes collectively referred to as the “client server.” The HTML server, the advertiser server-side processor and the advertiser database are sometimes collective referred to as the “advertiser server.”

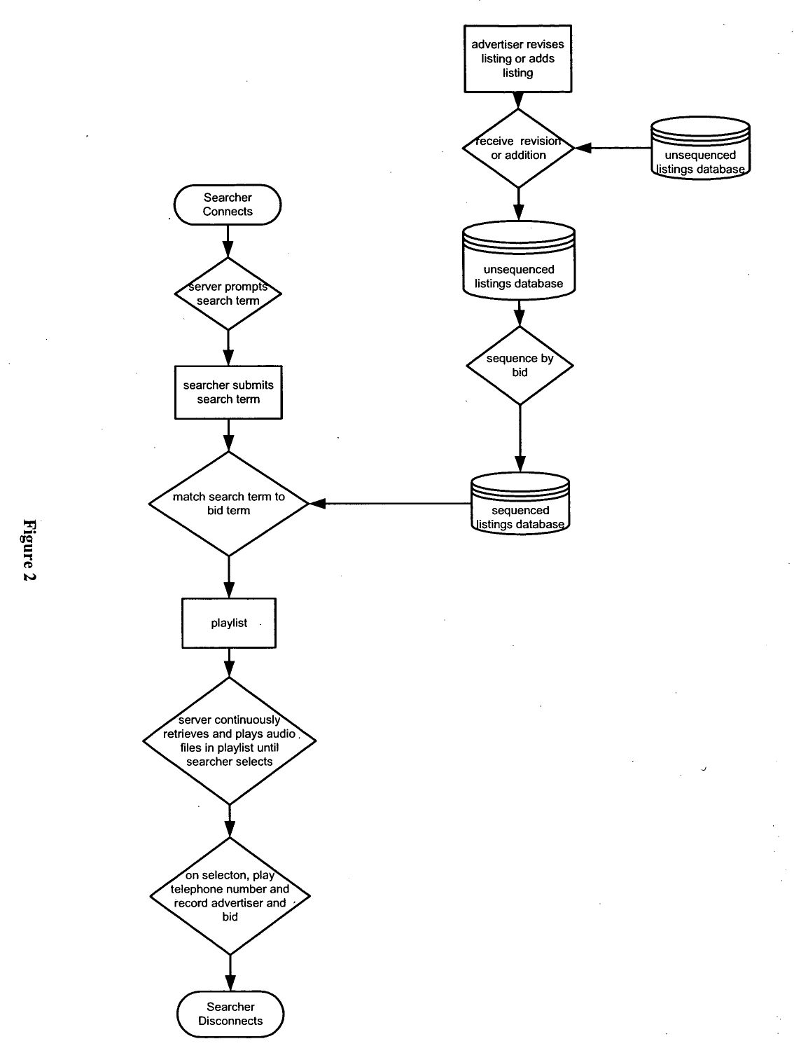

FIG. 2 is a flowchart of an embodiment of this invention showing retrieval of a playlist. First consider bid-time functions. An unsequenced listings database is provided, with the advertisements therein being audio files. It will be appreciated that the listings in this database may be optionally previously sequenced by bid. A revision to a listing or an additional listing is received for insertion into the unsequenced listings database. The listings in the unsequenced listings database are then sequenced by bid, producing a sequenced listings database.

Next consider search-time functions. The sequenced listings database maintained at bid-time is provided. A searcher connects to a voice browser. Upon connection, the client server prompts the consumer for a search term. It will be appreciated that the server may issue such prompt using a variety of methods known in the art, including but not limited to playing a voice file such as “press 1 for pizza, press 2 for dry cleaners” or using a text-to-speech decoder which decodes into audio text such as “please speak what you are looking for.” The user then submits a search term by speaking a term for voice recognition or by using DTMF. The client server then retrieves a playlist by selecting only those listings with a bid term that matches the search term. The client server then executes the playlist by continuously retrieving and playing the audio files in the playlist until the searcher barges in and selects an advertiser. On selection, the client server plays the selected advertiser's telephone number and records at least that advertiser's name and bid.

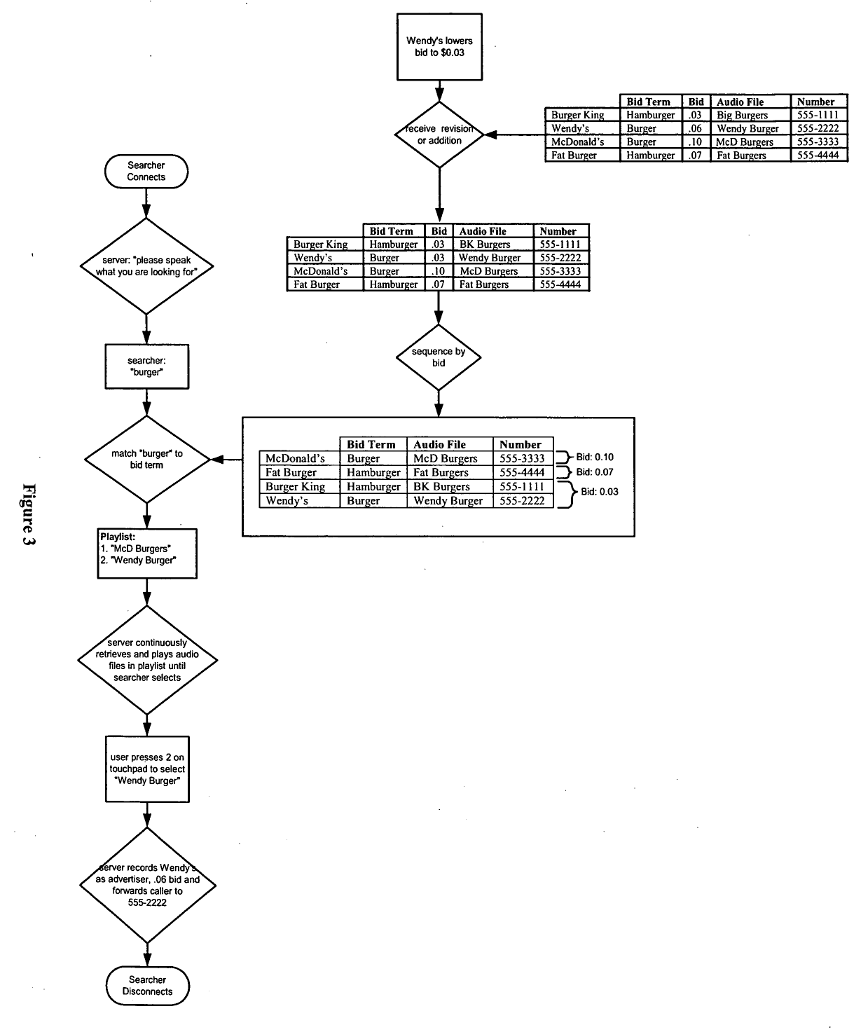

FIG. 3 is an example showing usage of the embodiment of this invention according to FIG. 2. Consider first bid-time functions. An unsequenced listings database is provided containing listings for Burger King, Wendy's, McDonald's ad Fat Burger, the advertisements therein being audio files. A revision decreasing Wendy's bid to $0.03 is received for insertion therein. The listings in the database are then sequenced to produce a sequenced database.

Next consider search-time functions. The sequenced listings database maintained at bid-time is provided. A searcher connects to a voice browser. Upon connection, the client server prompts the consumer for a search term. The searcher submits “burger.” The client server then retrieves the playlist shown by selecting only those listings with a bid term that matches “burger.” The client server will execute the play list. The searcher presses 2 on touchpad to select Wendy's. The client server then records that selection (along with the bid) and forwards the searcher to Wendy's at 555-2222.

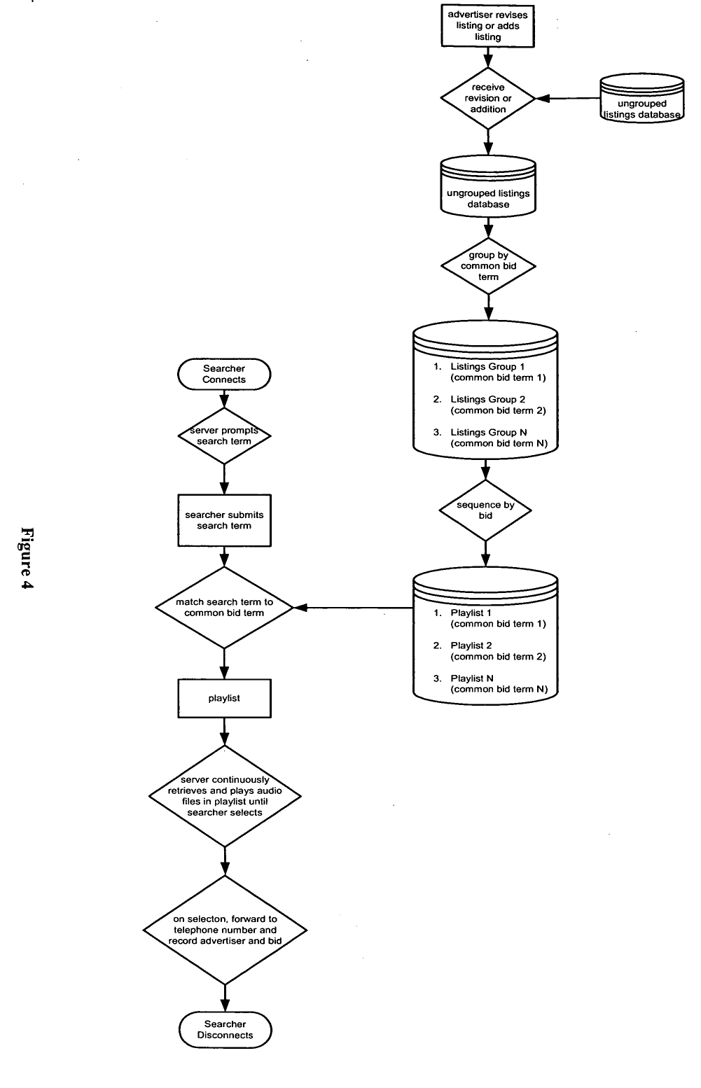

FIG. 4 is a flowchart of an embodiment of this invention showing retrieval of a playlist. First consider bid-time functions. An ungrouped listings database is provided. It will be appreciated that listings in this database may be optionally previously grouped together by bid term, with the listings in each such group optionally previously sorted by bid. A revision to a listing or an additional listing is received for insertion into the ungrouped listings database. The listings in said database are then grouped together by bid term. The listings in each group are then sequenced by bid to produce a playlist database. It will be appreciated that it is not crucial that the grouping function be executed before the sequence function. There is a single playlist in the playlist database for each common bid term.

Next consider search-time functions. The playlist database maintained at bid-time is provided. A searcher connects to a voice browser. Upon connection, the client server prompts the consumer for a search term. The user then submits a search term. The client server then retrieves a playlist by selecting that play list with a common bid term that matches the search term. The client server then executes the playlist by continuously retrieving and playing the audio files in the playlist until the searcher barges in and selects an advertiser. On selection, the client server plays the selected advertiser's telephone number and records at least that advertiser's name and bid.

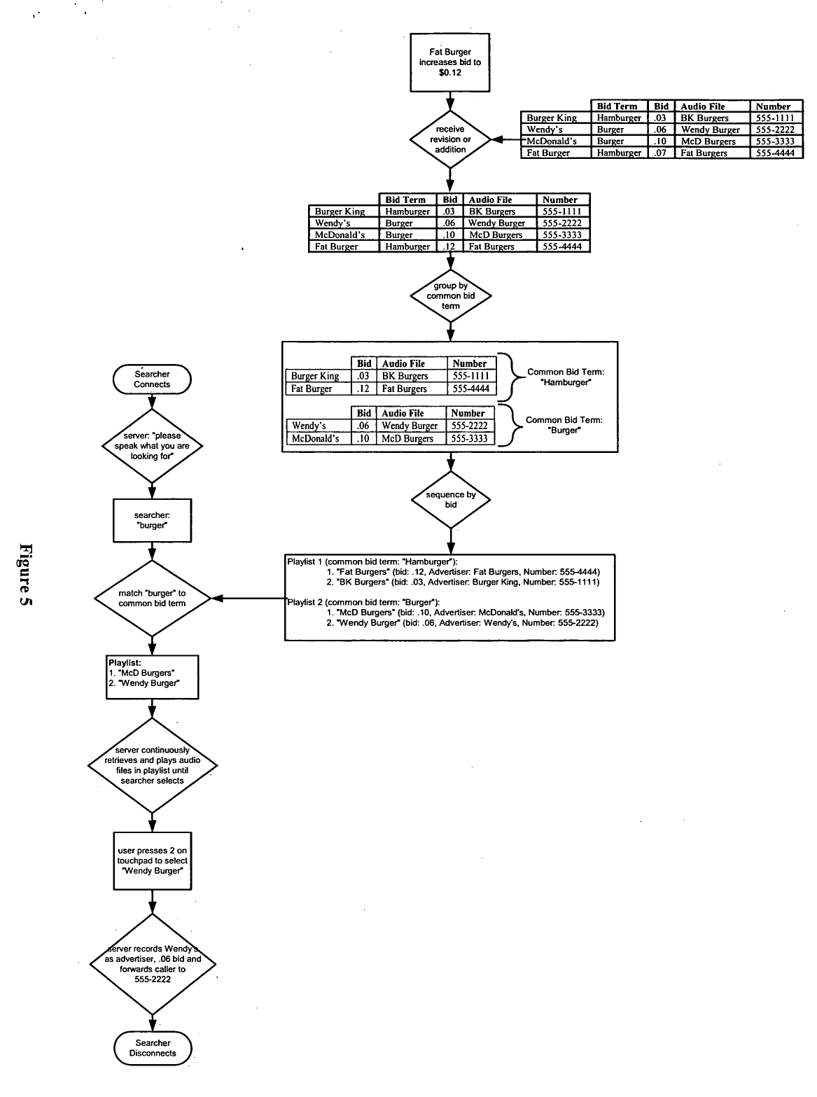

FIG. 5 is an example showing usage of the embodiment of this invention according to FIG. 4. Consider first bid-time functions. An ungrouped listings database is provided containing listings for Burger King, Wendy's, McDonald's ad Fat Burger, the advertisements therein being audio files. A revision increasing Fat Burger's bid to $0.12 is received for insertion therein. The listings therein are then grouped by common bid term producing a group for bid term “hamburger” and a group for bid term “burger.” The listings in each group are then sequenced by bid, producing playlist database with two playlists as shown.

Next consider search-time functions. The playlist database maintained at bid-time is provided. A searcher connects to a voice browser. Upon connection, the client server prompts the consumer for a search term. The searcher submits “burger.” The client server then retrieves the playlist shown by selecting the playlist with a common bid term that matches “burger.” The client server will execute the play list. The searcher presses 2 on touchpad to select Wendy's. The client server then records that selection (along with the bid) and forwards the searcher to Wendy's at 555-2222.

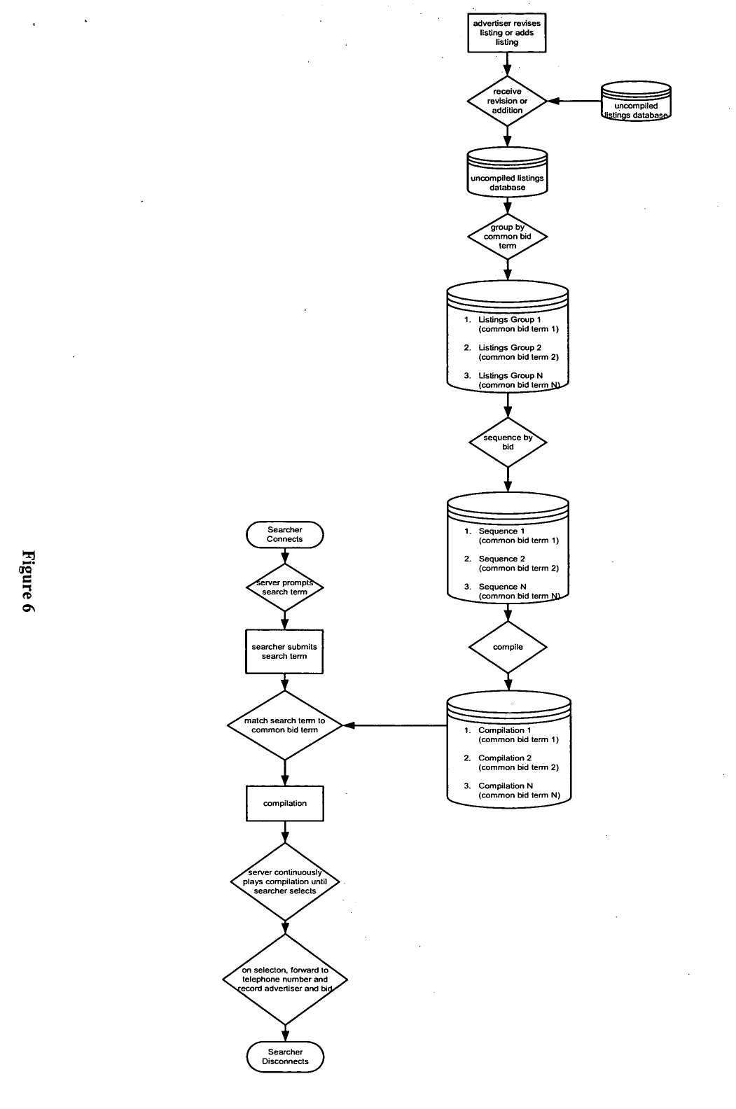

FIG. 6 is a flowchart of an embodiment of this invention showing retrieval of a compilation. First consider bid-time functions. An uncompiled listings database is provided. It will be appreciated that listings in this database may be optionally previously compiled into compilations. A revision to a listing or an additional listing is received for insertion into the ungrouped listings database. The listings in said database are then grouped together by bid term. The listings in each group are then sequenced by bid. It will be appreciated that it is not crucial that the grouping function be executed before the sequence function. Each sequence is then compiled into a compilation to produce a compilation database. There is a single compilation in the compilation database for each common bid term.

Next consider search-time functions. The compilation database maintained at bid-time is provided. A searcher connects to a voice browser. Upon connection, the client server prompts the consumer for a search term. The user then submits a search term. The client server then retrieves a compilation by selecting that compilation with a common bid term that matches the search term. The client server then plays the compilation until the searcher barges in and selects an advertiser. On selection, the client server plays the selected advertiser's telephone number and records at least that advertiser's name and bid.

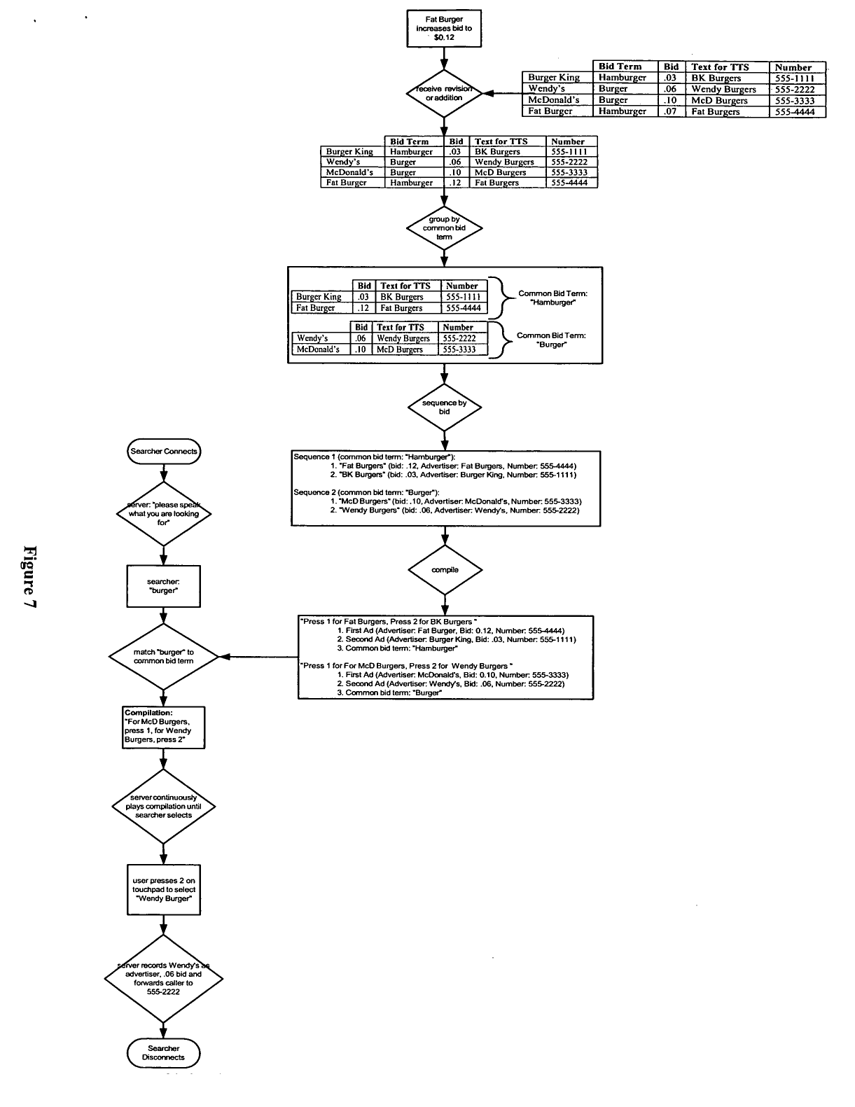

FIG. 7 is an example showing usage of the embodiment of this invention according to FIG. 6. Consider first bid-time functions. An uncompiled listings database is provided containing listings for Burger King, Wendy's, McDonald's ad Fat Burger, the advertisements therein being text for TTS. A revision increasing Fat Burger's bid to $0.12 is received for insertion therein. The listings therein are then grouped by common bid term producing a group for bid term “hamburger” and a group for bid term “burger.” The listings in each group are then sequenced by bid. Finally, each sequenced group is compiled, producing compilation database with two compilations as shown. It will be appreciated in this example that selection prompts (“Press 1 for . . . ”) have been compiled into the compilation.

Next consider search-time functions. The compilation listings database maintained at bid-time is provided. A searcher connects to a voice browser. Upon connection, the client server prompts the consumer for a search term. The searcher submits “burger.” The client server then retrieves the compilation shown (“For McD Burgers, press 1, for Wendy Burgers, press 2”) by selecting the compilation with a common bid term that matches “burger.” The client server will play the compilation. The searcher presses 2 on touchpad to select Wendy's. The client server then records that selection (along with the bid) and forwards the searcher to Wendy's at 555-2222.

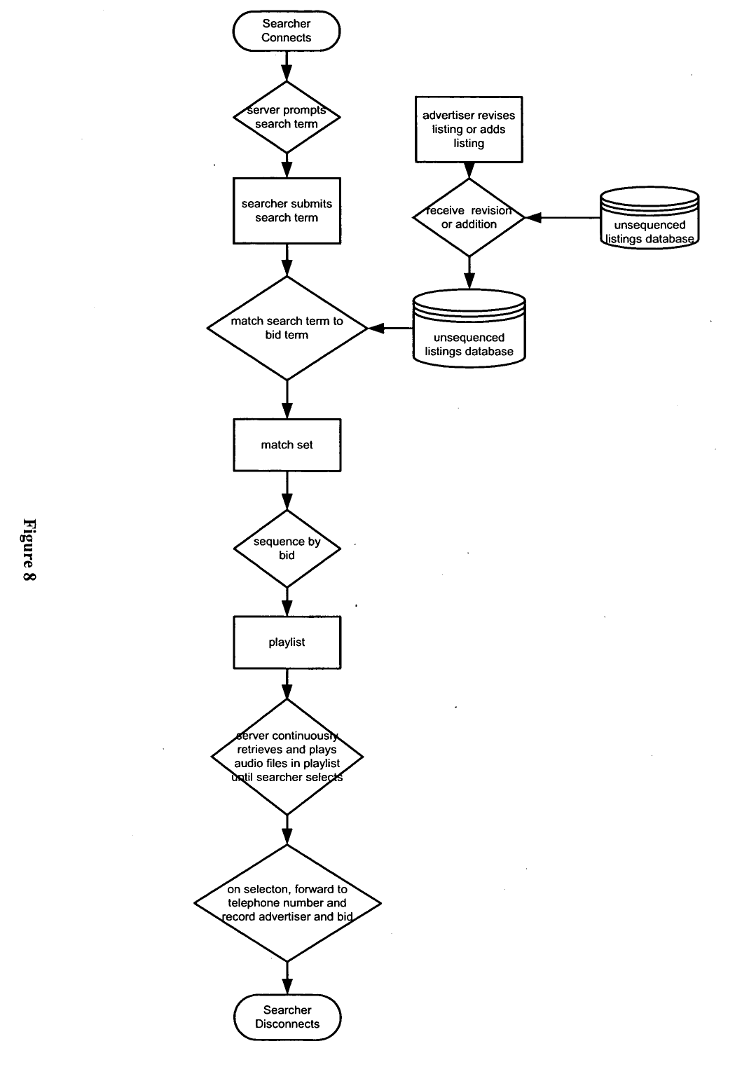

FIG. 8 is a flowchart of an embodiment of this invention showing generation (rather than retrieval) of a playlist. First consider bid-time functions. An unsequenced listings database is provided. A revision to a listing or an additional listing is received for insertion into the unsequenced listings database. No additional functions are executed at bid-time.

Next consider search-time functions. The listings database maintained at bid-time is provided. A searcher connects to a voice browser. Upon connection, the client server prompts the consumer for a search term. The user then submits a search term. The client server then generates a match set by selecting those listings with a bid term that matches the search term. The client server then sequences the match set by bid, creating a playlist. The client server executes the playlist until the searcher barges in and selects an advertiser. On selection, the client server plays the selected advertiser's telephone number and records at least that advertiser's name and bid.

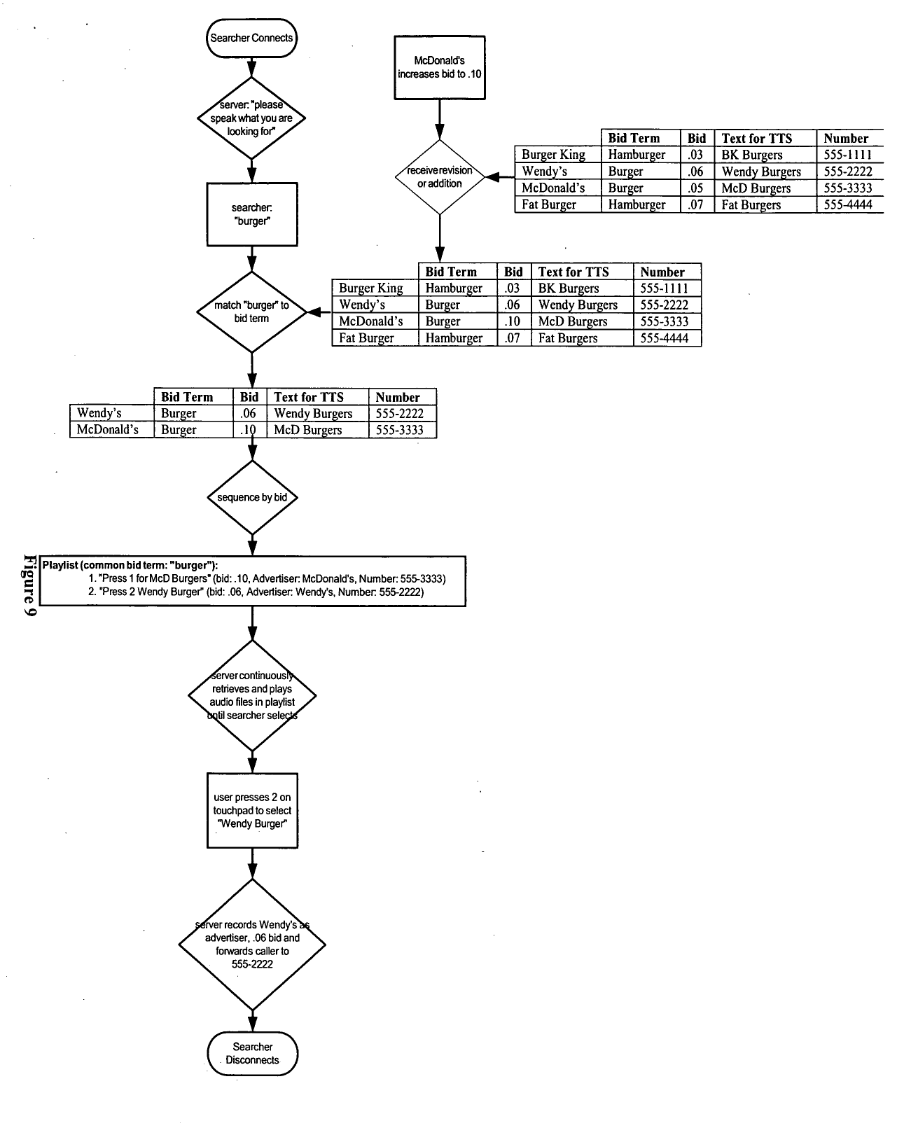

FIG. 9 is an example showing usage of the embodiment of this invention according to FIG. 8. Consider first bid-time functions. A listings database is provided containing listings for Burger King, Wendy's, McDonald's ad Fat Burger, with the advertisements therein being text for TTS translation. A revision increasing McDonald's bid to $0.10 is received for insertion therein.

Next consider search-time functions. The listings database maintained at bid-time is provided. A searcher connects to a voice browser. Upon connection, the client server prompts the consumer for a search term. The searcher submits “burger.” The client server then generates the match set shown by selecting those listings with a bid term that matches “burger.” The client server then sequences the match set by bid, creating the play list shown. The client server then executes the playlist. The searcher presses 2 on touchpad to select Wendy's. The client server then records that selection (along with the bid) and forwards the searcher to Wendy's at 555-2222.

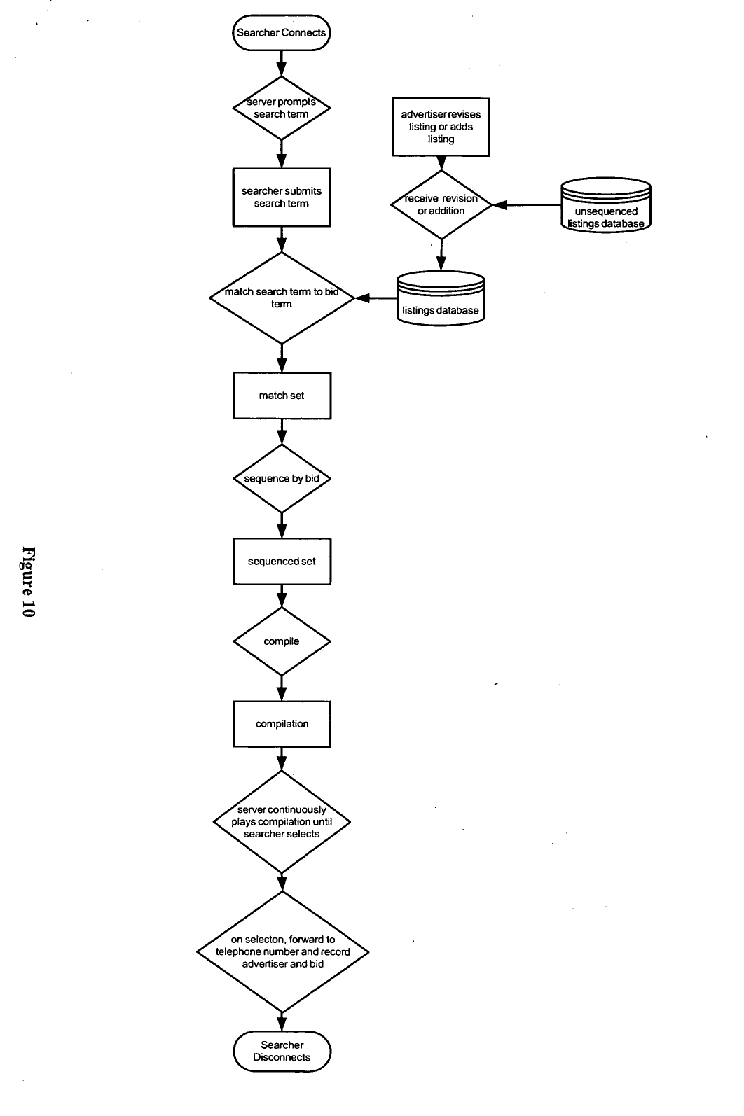

FIG. 10 is a flowchart of an embodiment of this invention showing generation (rather than retrieval) of a compilation. First consider bid-time functions. An uncompiled listings database is provided. A revision to a listing or an additional listing is received for insertion into the uncompiled listings database. No additional functions are executed at bid-time.

Next consider search-time functions. The uncompiled listings database maintained at bid-time is provided. A searcher connects to a voice browser. Upon connection, the client server prompts the consumer for a search term. The user then submits a search term. The client server then generates a match set by selecting those listings with a bid term that matches the search term. The client server then sequences the match set by bid. Finally, the client server compiles the sequence into a compilation. The client server plays the compilation until the searcher barges in and selects an advertiser. On selection, the client server plays the selected advertiser's telephone number and records at least that advertiser's name and bid.

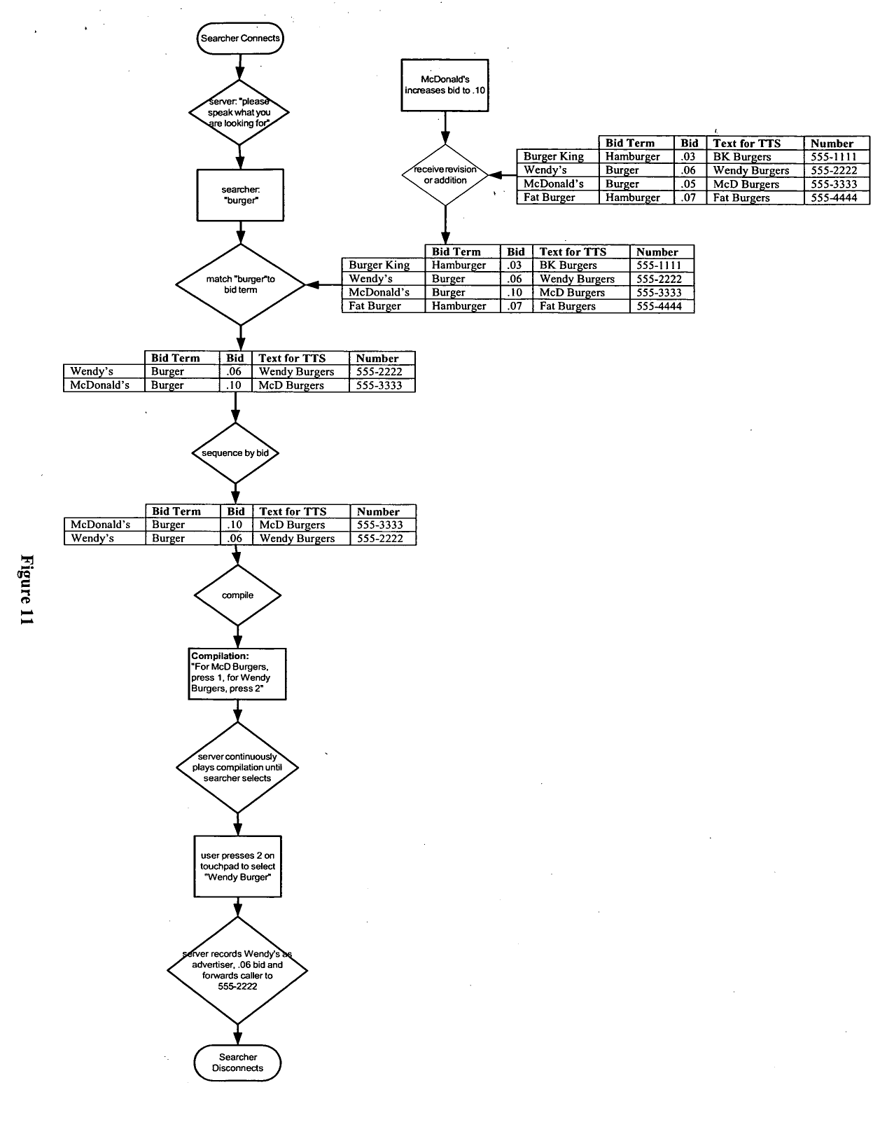

FIG. 11 is an example showing usage of the embodiment of this invention according to FIG. 10. Consider first bid-time functions. An uncompiled listings database is provided containing listings for Burger King, Wendy's, McDonald's ad Fat Burger. A revision increasing McDonald's bid to $0.10 is received for insertion therein.

Next consider search-time functions. The uncompiled listings database maintained at bid-time is provided. A searcher connects to a voice browser. Upon connection, the client server prompts the consumer for a search term. The searcher submits “burger.” The client server then generates the match set shown by selecting those listings with a bid term that matches “burger.” The client server then sequences the match set by bid as shown. The client server then compiles the sequence, together with selection prompts, into the following compilation: “For McD Burgers, press 1, for Wendy Burgers, press 2. The client server then plays the compilation. The searcher presses 2 on touchpad to select Wendy's. The client server then records that selection (along with the bid) and forwards the searcher to Wendy's at 555-2222.

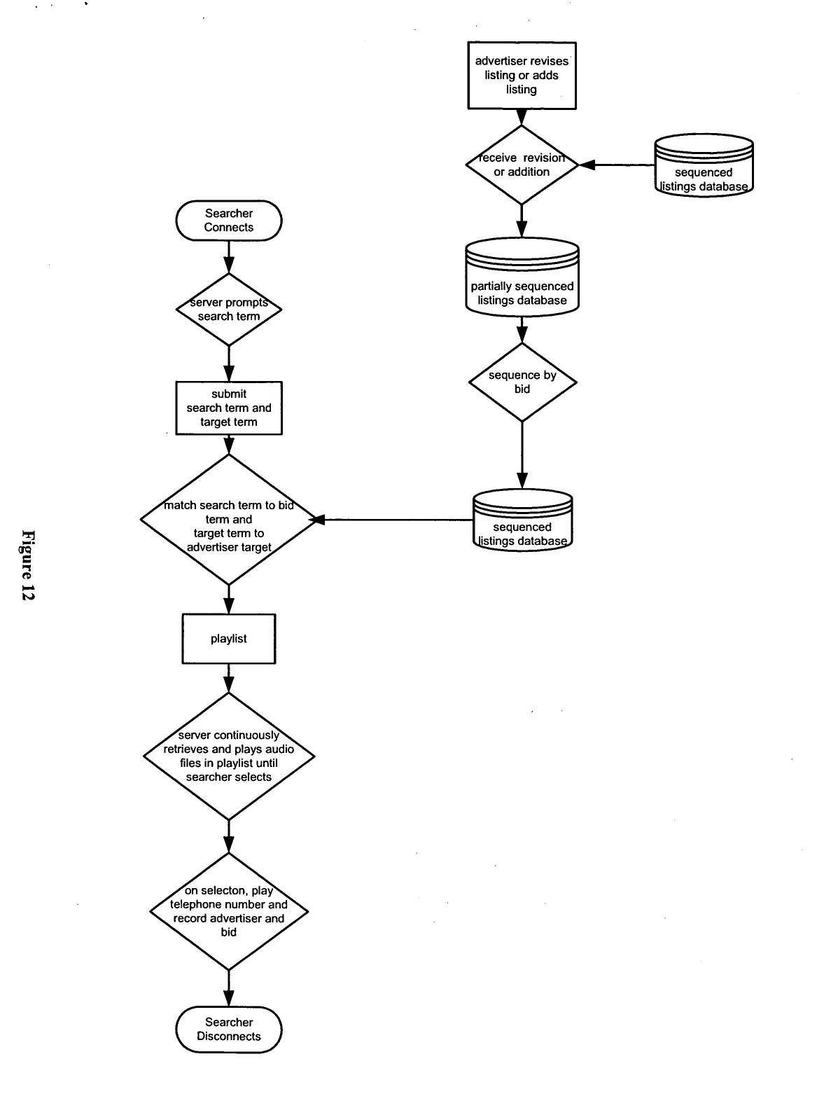

FIG. 12 is a flowchart of an embodiment of this invention showing retrieval of a targeted playlist. Targeting is an embodiment whereby merchants bid for preferential position in a play list or compilation, but that bid is made only for searchers within some defined geographic area, or only for searchers with some defined demographic trait, or only for some other limiting factor. First consider bid-time functions. A sequenced listings database is provided. It will be appreciated that the listings database may be optionally unsequenced. It will also be appreciated that the listings in the listings database may optionally be grouped by advertiser target, with the listings in each such group thereafter optionally sorted by bid. It will also be appreciated that the listings in the listings database may optionally be grouped by bid term, with the listings in each such group thereafter optionally sorted by bid. A revision to a listing or an additional listing is received for insertion into the unsequenced listings database, producing possibly a partially sequenced listings database. The listings in said database are then sequenced by bid, producing a sequenced listings database. Next consider search-time functions. The sequenced database maintained at bid-time is provided. A searcher connects to a voice browser. Upon connection, the client server prompts the consumer for a search term and target term. Searcher then submits a search term and target term. It will be appreciated that the target term may be submitted by a searcher, by the client server or by a third party. The client server then retrieves a playlist by selecting only those listings with a bid term that matches the search term and with an advertiser target that matches the target term. The client server then executes the playlist by continuously retrieving and playing the audio files in the playlist until the searcher barges in and selects an advertiser. On selection, the client server plays the selected advertiser's phone number and records at least that advertiser's name and bid.

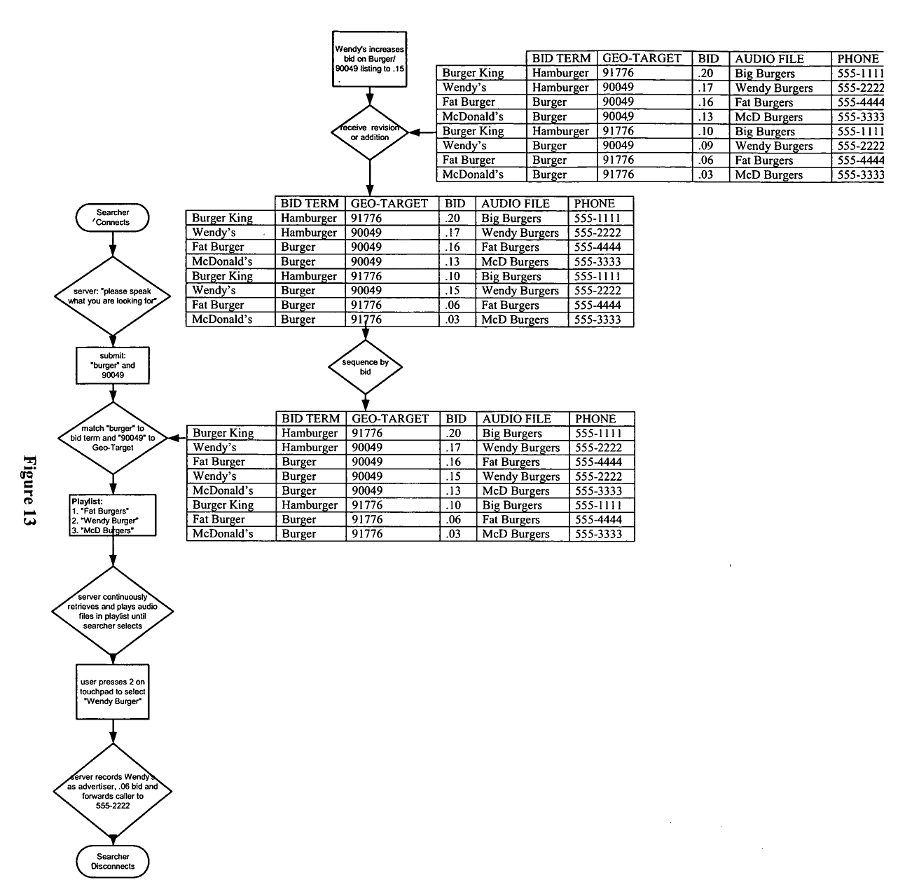

FIG. 13 is an example showing usage of the embodiment of this invention according to FIG. 12. In this example advertisers are targeting searchers in defined geographic areas. Consider first bid-time functions. A sequenced listings database is provided containing listings for Burger King, Wendy's, McDonald's ad Fat Burger. These advertisers have made bids on “hamburger” and “burger” in either the “91776” geo-target or the “90049” geo-target. A revision increasing Wendy's bid on “burger” in the “90049” geo-target to $0.15 is received for insertion into the sequenced listings database, producing a partially sequenced listings database as shown. The listings in said database are then sequenced by bid, producing a sequenced listings database.

Next consider search-time functions. The sequenced listings database maintained at bid-time is provided. A searcher connects to a voice browser. Upon connection, the client server prompts the consumer for a search term and a target term. The searcher submits “burger” and “90049.” The client server then generates the match set shown by selecting those listings with a bid term that matches “burger.” The client server then retrieves a playlist by selecting only those listings with a bid term that matches the search term and with an advertiser target that matches the target term.

The playlist is:
1. Fat Burgers
2. Wendy Burger
3. McD Burgers

The client server continuously retrieves and plays the audio files in the play list until the searcher barges in an selects an advertiser. The searcher presses 2 on touchpad to select Wendy's. The client server then records that selection (along with the bid) and forwards the searcher to Wendy's at 555-2222.

1. A method for delivering a compilation, comprising:
receiving a search term; and
from a database of plural compilations of advertisements, each compilation having a bid term and each advertisement in each of said compilations having an advertiser, a bid, a bid term, and optionally a forwarding number, the advertisements in each of said compilations previously sequenced by bid, retrieving that compilation whose bid term matches the search term.

2. The method of claim 1 comprising the further step of playing the compilation.

3. The method of claim 2 comprising the further steps of:
receiving from the searcher a request for a forwarding number;
recording at least the bid and advertiser associated with said requested forwarding number.

4. The method of claim 2 comprising the further steps of:
receiving from the searcher a request to forward to a forwarding number;
in any order,
recording at least the bid and advertiser associated with said requested forwarding number; and
forwarding the searcher to said requested forwarding number.

5. A method for generating a compilation, comprising:
receiving a search term;
from a database of plural listings, each listing having an advertiser, a bid term, a bid, an advertisement, and optionally a forwarding number, selecting those listings whose bid term matches the search term;
sequencing such selected listings by bid; and
compiling such sequenced listings into a compilation.

6. A method for generating and executing a playlist for a collection of audio advertisements, comprising:
receiving a search term from a searcher; and
from a database of plural listings, each listing having an advertiser, a bid term, a bid, an audio advertisement, and optionally a forwarding number, generating a playlist by retrieving those listings whose bid term matches the search term; and
executing the playlist.

7. The method of claim 6 wherein the audio advertisements in said playlist are sequenced by bid before execution of said playlist.

8. The method of claim 6 wherein the listings in the said database of plural listings have been previously sequenced by bid.

9. The method of claim 6 comprising the further steps of:
receiving a request for a forwarding number from the searcher;
recording at least the bid and advertiser associated with said requested forwarding number.

10. The method of claim 7 comprising the further steps of:
receiving a request for a forwarding number from the searcher;
recording at least the bid and advertiser associated with said requested forwarding number.

11. The method of claim 8 comprising the further steps of:
receiving a request for a forwarding number from the searcher;
recording at least the bid and advertiser associated with said requested forwarding number.

12. The method of claim 6 comprising the further steps of:
receiving from the searcher a request to forward to a forwarding number;
in any order,
recording at least the bid and advertiser associated with said requested forwarding number; and
forwarding the searcher to said requested forwarding number.

13. The method of claim 7 comprising the further steps of:
receiving from the searcher a request to forward to a forwarding number;
in any order,
recording at least the bid and advertiser associated with said requested forwarding number; and
forwarding the searcher to said requested forwarding number.

14. The method of claim 8 comprising the further steps of:
receiving from the searcher a request to forward to a forwarding number;
in any order,
recording at least the bid and advertiser associated with said requested forwarding number; and
forwarding the searcher to said requested forwarding number.
